(19) United States
(12) Patent Application Publication
(10) Pub. No.: US 2012/0076414 A1
(43) Pub. Date: Mar. 29, 2012

(54) External Image Based Summarization Techniques

(75) Inventors: Jizheng Xu, Beijing (CN); Binxing Jiao, Hefei City (CN); Feng Wu, Beijing (CN)

(73) Assignee: MICROSOFT CORPORATION, Redmond, WA (US)

(21) Appl. No.: 12/891,552

(22) Filed: Sep. 27, 2010

(51) Int. Cl. G06K 9/34; G06F 17/30

(52) U.S. Cl. 382/176; 707/769; 707/E17.03

(57) ABSTRACT

Techniques involve visually summarizing documents (e.g., search results, a collection of documents, etc.) using images which are visually representative of the documents for which the images represent. The images representing the documents may be external images obtained from sources other than the documents. The external images may be obtained from the sources other than the documents by performing a separate image based search using key phrases from the documents rather than extracting the images directly from within the documents themselves. Alternatively, an algorithm may be used to determine an image type, which may be chosen from a selection of external images, thumbnail images, or internal imaged taken directly from the collection of documents, that is suited to represent each document in the collection of documents. A snippet of the documents may be displayed along with the images which visually represent each of the documents.

### BACKGROUND

Search engines may aid users seeking information on the World Wide Web and other databases by displaying search results (i.e., web pages) based on a query submitted by a user. Some search engines may use visual summarization techniques to visually summarize the search results using images that are relevant to the search results.

For example, some visual summarization techniques may summarize the search results using images that are extracted directly from the search result documents. Although such techniques may effectively summarize search result documents that contain salient images, such techniques are unavailable for documents which do not contain any images.

### SUMMARY

External image based visual summarization techniques involve visually summarizing documents (e.g., search results, a collection of documents, etc.) using images that represent the documents. Initially, the documents are received. Next, an image is selected to visually represent each of the documents.

In some embodiments, the images may be external images obtained from sources other than the documents. For example, the image search engine may perform a separate image-based search using key phrases from the documents, which in turn are used to locate images (external images) in the other sources rather than extracting the images directly from within the documents themselves.

Alternatively, the techniques may use an algorithm to choose an image type, which may be chosen from a selection of external images obtained from sources other than the documents, thumbnail images, or internal images taken directly from the documents themselves, that is suited to visually summarize each of the documents. For example, in some embodiments, a structure of the documents may be analyzed to choose the image type (i.e., external images obtained from sources other than the documents, thumbnail images, or internal images taken directly from the documents themselves) that is best suited to represent each of the documents.

Finally, a snippet of the documents may be included along with the images that visually summarize each of the documents.

### BRIEF DESCRIPTION OF THE DRAWINGS

The detailed description is described with reference to the accompanying figures. In the figures, the left-most digit(s) of a reference number identifies the figure in which the reference number first appears. The same reference numbers in different figures indicate similar or identical items.

FIG. 1 is a schematic diagram of an illustrative environment used to visually summarize documents using images in accordance with external image based summarization techniques.

FIG. 2 depicts an illustrative web site that visually summarizes search results using external images obtained from sources other than the documents in accordance with external image based summarization techniques.

FIG. 3 is a pictorial flow diagram of an illustrative process of selecting external images from sources other than the documents to visually summarize documents in accordance with external image based summarization techniques.

FIG. 4 is a flow diagram of an illustrative process of selecting external images from sources other than the documents to visually summarize search results in accordance with external image based summarization techniques.

FIG. 5 depicts an illustrative web site that visually summarizes documents using external images obtained from sources other than the documents in combination with other visual summarization techniques.

FIG. 6 is a flow diagram of an illustrative process of analyzing a document structure to choose an image type that is suited to visually summarize search results.

FIG. 7 depicts an illustrative web site that visually summarizes a collection of documents using images in accordance with external image based summarization techniques.

FIG. 8 is a flow diagram of an illustrative process of summarizing a collection of documents in accordance with external image based summarization techniques.

### DETAILED DESCRIPTION

### Overview

External image based visual summarization pertains to visually summarizing documents (e.g., search results, a collection of documents, etc.) using external images. As used herein, “external images” are images that are used to visually summarize a document or collection of documents but are not included within or linked to the document(s) that the images represent. In accordance with this definition, any images that appear in a display of a document when rendered by a web browser are not considered external images of the document. The external images may be obtained from other sources by performing a separate image based search using key phrases from the document(s).

For example, a user may perform a search query using a search term of “living” to retrieve search results which are representative of the search term “living”. The search results may be represented with, or accompanied by, an external image that is selected from the other sources via an image based search which is separate from the document search query. Thus, even documents that only contain text may be represented with, or accompanied by, the external images in the search result.

The techniques described herein may use an algorithm to choose an image type (e.g., external images obtained from sources other than the documents, thumbnail images, internal images taken directly from the documents themselves, etc.) that is suited to visually summarize each of the documents. For example, if a document contains a salient image, then it may be advantageous to represent that document using the salient image. As another example, if the document is discernibly recognizable using a scaled-down snapshot image of the document itself as rendered by a web browser (i.e., the document has a simple structure which may be determined by analyzing one or more of a character count, frame count, image size, word count, and/or font size), then it may be advantageous to represent that document using a thumbnail image. As a further example, if a document does not contain any salient images, has a complex structure, or otherwise lacks discernable attributes when converted to a thumbnail image, then it may be advantageous to represent that document using an external image that is selected from a source other than the document itself.

Although the techniques described herein are presented in accordance with performing web based search queries, it should be appreciate that the techniques may be used to visually summarize any document or collection of documents which are stored in memory. For instance, the techniques may be used to visually summarize search results or a collection of documents, such as a collection of recently accessed documents, a collection of bookmarked documents, a collection of top sites, and so forth.

The processes and systems described herein may be implemented in a number of ways. Example implementations are provided below with reference to the following figures.

### Illustrative Architecture

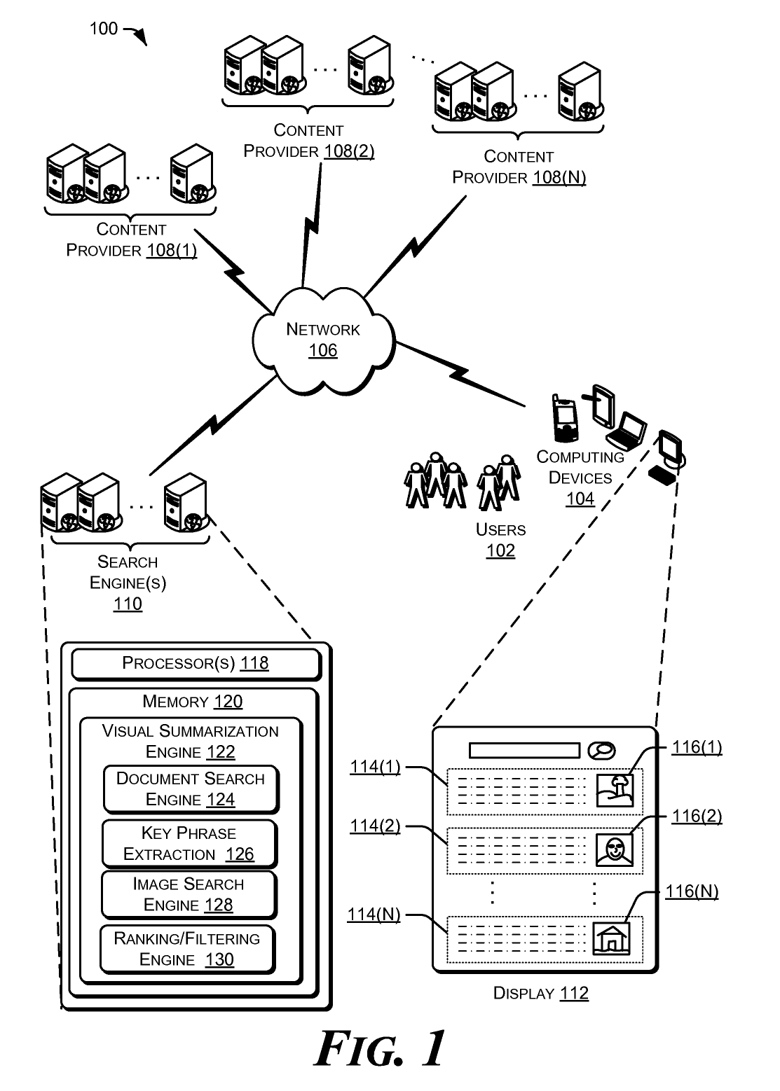

FIG. 1 depicts an illustrative architecture 100 that may employ the techniques. As illustrated, FIG. 1 includes one or more users 102, each operating respective computing devices 104, to search for content over a network 106. The computing devices 104 may include any sort of device capable of performing searches and uploading and downloading content (e.g., documents, text, images, videos, etc.). For instance, the computing devices 104 may include personal computers, laptop computers, mobile phones, set-top boxes, game consoles, personal digital assistants (PDAs), portable media players (PMPs) (e.g., portable video players (PVPs) and digital audio players (DAPS)), and other types of computing devices. Note that network 106, which couples the computing devices 104, may include the Internet, a Local Area Network (LAN), a Wide Area Network (WAN), a wireless network, and/or other types of networks.

Additionally, FIG. 1 illustrates content providers 108(1), 108(2), . . . , and 108(N). Content providers 108(1)-(N) may include any sort of entity (e.g., databases, web sites, etc.) that can store files such as text documents, multi-media, web pages and other files. Each of the respective content providers 108(1)-(N) may be connected to other content providers via the network 106. In addition, the content providers 108(1)-(N) may be further connected to the computing devices 104 via the network 106.

One or more search engine(s) 110 may retrieve the various files stored at the content providers 108(1)-(N) via the network 106. For instance, the search engine(s) 110 may perform a search query on the content providers 108(1)-(N) via the network 106 to retrieve documents from the content providers. Moreover, the search engine(s) 110 may be further connected to the computing devices 104 via the network 106 such that the search engine(s) 110 may retrieve the documents and then transmit the documents to the computing devices 104.

Upon retrieving the documents the computing devices 104 may render a display 112 of the documents as a list 114(1), 114(2), . . . , and 114(N) of representative documents for viewing by the users 102. For example, each element in the list 114(1)-(N) may be a representation of each of the retrieved documents, respectively. Each document represented on the display may include an image 116(1), 116(2), . . . , and 116(N) that visually summarizes each of the documents, respectively.

In some embodiments, the images 116(1)-(N) include a selection of one or more of external images obtained from sources other than the documents, thumbnail images, or internal images directly from the documents themselves to visually summarize each of the documents. For instance, an algorithm may be executed to choose an image type from a selection of external images, thumbnail images, or internal images taken directly from the documents themselves that is suited to visually summarize each of the documents in the list 114(1)-(N).

In some instances, the list 114(1)-(N) of documents represent search results such as one or more documents retrieved by performing a document search query. In other instances, the list 114(1)-(N) of documents represent any collection of documents (e.g., a collection of recently accessed documents, a collection of bookmarked documents, a collection of top sites, etc.) which may be requested by the users 102. It should be appreciated that the returned documents may be documents which are stored locally to the search engine(s) 110 and/or the returned documents may be documents stored in a database such as illustrated by the content providers 108(1)-(N) and accessed using the network 106.

As illustrated, search engine(s) 110 includes one or more processors 118, as well as memory 120, upon which a visual summarization engine 122 may reside. The visual summarization engine 122 may serve to display the list 114(1)-(N) of documents including the images 116(1)-(N) which visually summarizes each of the documents. In some instances, the images 116(1)-(N) are external images obtained from sources other than the documents which the images represent by performing a separate image based search using key phrases extracted from the documents of which the images represent. In other instances, the visual summarization engine 122 may execute a selection algorithm to choose an image type, which may be chosen from a selection of external images, thumbnail images, or internal images taken directly from the documents themselves, that is suited to visually summarize each of the documents.

In the non-limiting architecture of FIG. 1, the visual summarization engine 122 is executed on search engine(s) 110. The visual summarization engine 122 may include a document search engine 124, a key phrase extraction engine 126, an image search engine 128, and a ranking/filtering engine 130. Collectively, the engines 124-130 may perform various operations to display the list 114(1)-(N) of documents including the images 116(1)-(N) which visually summarizes the documents.

In general, the document search engine 124 retrieves the documents. The key phrase extraction engine 126 extracts key phrases from the documents. The image search engine 128 uses the key phrases to find candidate images which are visually representative of the documents. The ranking/filtering engine 130 filters the candidate images to select a representative image to represent each of the documents. For example, the visual summarization engine 122 may contain instructions which, when executed by the processor(s) 118, cause the processor(s) 118 to do the following: retrieve a document, extracting key phrase(s) from the document that represents a main topic of the document, perform an image based search based at least in part on the key phrase to identify one or more candidate images, select a representative image from the candidate images to visually represent the document, and render a representation of the document that includes the representative image.

Additional reference will be made to these engines in the following sections.

### Illustrative Presentation

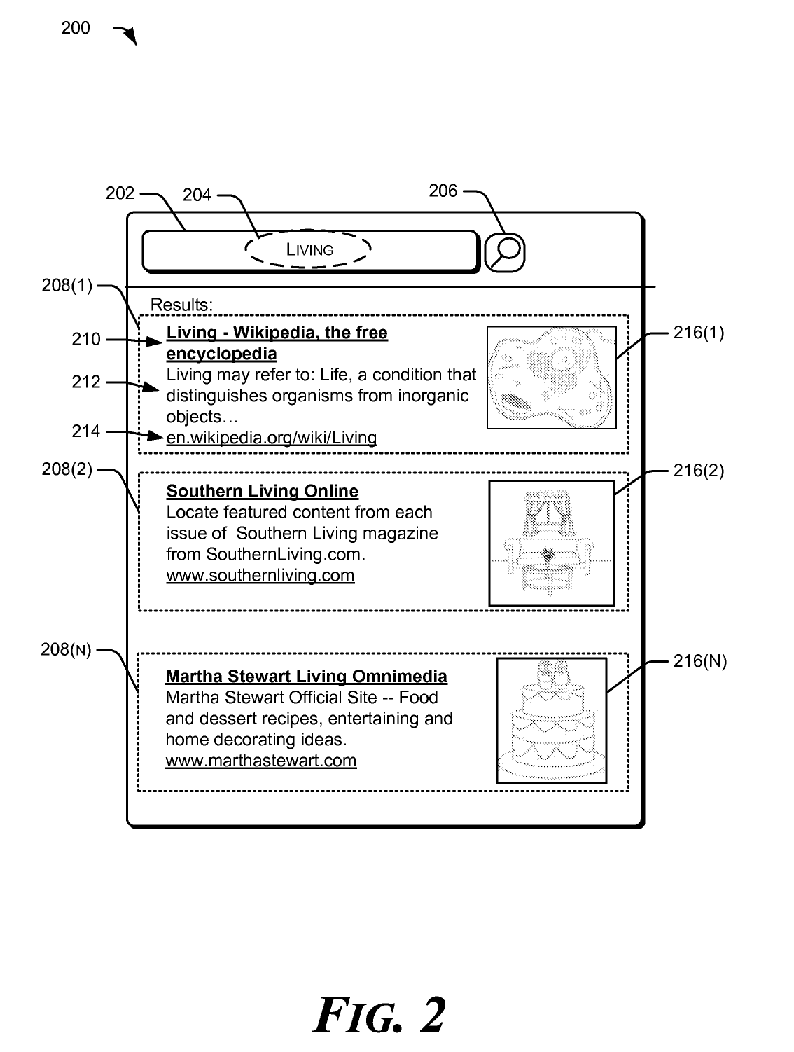

FIG. 2 is an illustrative web page 200 that may be operable to display results of a search query along with an external image that is obtained from sources other than the results. The web page 200 is described with reference to the architecture 100 of FIG. 1.

The search engine(s) 110 may display the web page 200. The illustrative web page 200 may include a search term input box 202 to receive a search term 204 from a user, for example. The web page 200 may additionally include a search command 206 operable to execute the search query via the document search engine 124.

The document search engine 124 may query a database such as illustrated by the content providers 108(1)-(N) using the network 106 to retrieve search results based on the search term 204 and display a representation of the search results as a list 208(1), 208(2), . . . , and 208(N), for example. For instance, if the word “living” is received as the search term 204, then the document search engine 124, such as, without limitation, Microsoft's Bing® search engine, may perform the search query to retrieve search results pertaining to the word “living”. The document search engine 124 may then represent the search results on the display as a list 208(1)-(N). For instance, the document search engine 124 may display a representation of a Wikipedia web site 208(1) that defines the word living, a representation of a web site pertaining to the Southern Living Magazine 208(2), and representation of a Martha Stewart Official web site 208(N), for example.

The list 208(1)-(N) may include any combination of information such as a document title 210 that reflects a title of the search result represented in the list, a snippet 212 that describes the search result represented in the list using one or more phrases, and/or a document locator 214 that specifies where the search result represented in the list is available for retrieval.

The list 208(1)-(N) of results may additionally include an image 216(1), 216(2), . . . , and 216(N) that visually represents each document represented by the list 208(1)-(N), respectively. For instance, image 216(1) represents the Wikipedia web site 208(1), image 216(2) represents the web site pertaining to the Southern Living Magazine 208(2), and image 216(N) represents the Martha Stewart Official web site 208(N).

In some instances, the images 216(1)-(N) are obtained from sources other than the documents of which the images represent by performing a separate image-based search using key phrases extracted from the search result documents of which the images represent. In some embodiments, an algorithm is used to choose an image type, which may be chosen from a selection of external images, thumbnail images, or internal images taken directly from the documents themselves, that is suited to visually summarize each of the documents.

### Illustrative Process

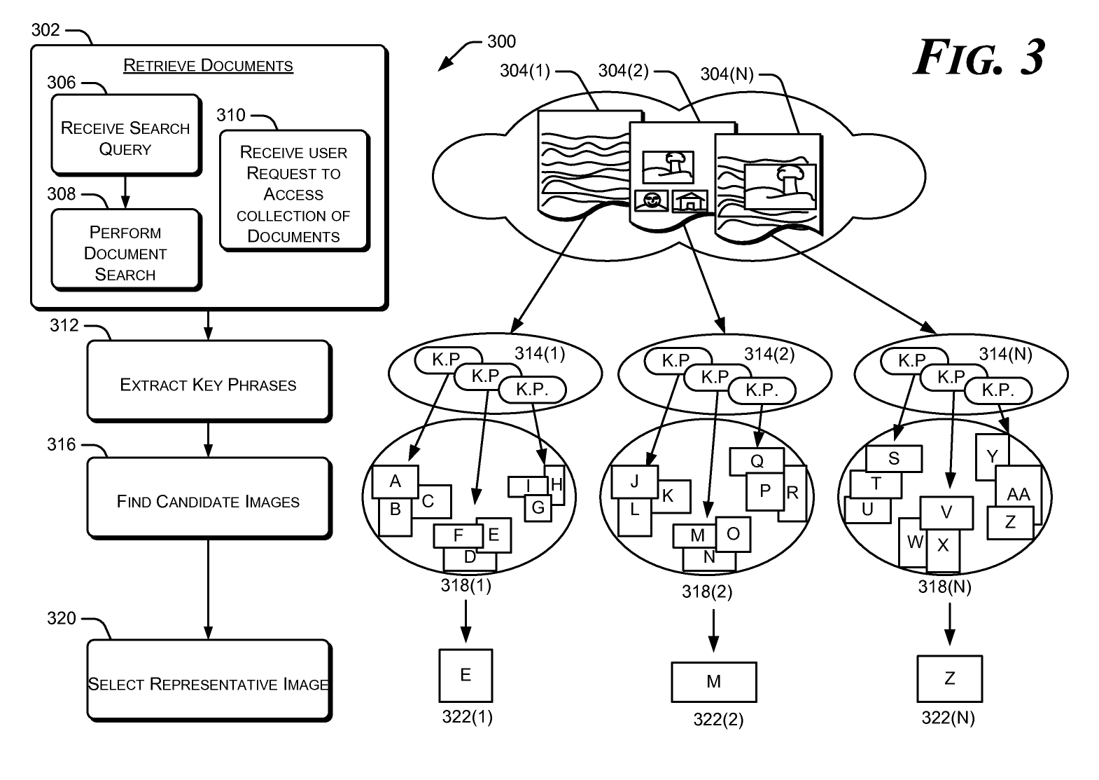

FIG. 3 is a pictorial flow diagram of an illustrative process 300 of visually summarizing documents using external images obtained from sources other than the documents which the images represent. The process 300 may be performed by the visual summarization engine 122.

The process 300 is illustrated as a collection of blocks in a logical flow graph, which represent a sequence of operations that can be implemented in hardware, software, or a combination thereof. In the context of software, the blocks represent computer-executable instructions that, when executed by one or more processors, cause the one or more processors to perform the recited operations. Generally, computer-executable instructions include routines, programs, objects, components, data structures, and other types of executable instructions that perform particular functions or implement particular abstract data types. The order in which the operations are described is not intended to be construed as a limitation, and any number of the described blocks can be combined in any order and/or in parallel to implement the process. Other processes described throughout this disclosure, in addition to process 300, shall be interpreted accordingly.

At 302, the visual summarization engine 122 retrieves documents 304(1), 304(2), . . . , and 304(N). In some instances, the documents 304(1)-(N) may be retrieved in response to a request from the user 102 via the client devices 104. The visual summarization engine 122 may retrieve the documents 304(1)-(N) at 302 directly from the memory 120 of the search engine(s) 110, or the visual summarization engine 122 may retrieve the documents at 302 from a database such as illustrated by the content providers 108(1)-(N) using the network 106.

In some embodiments, the documents 304(1)-(N) retrieved at 302 represent search results. In such instances, the visual summarization engine 122 may first receive a search term 204 from the user 102 at 306 and then the document search engine 124 may perform a search query at 308 using the search term to retrieve the documents 304(1)-(N) (i.e., search results) at 302. The documents 304(1)-(N) may be retrieved from the content providers 108(1)-(N) using the network 106.

Alternatively, the documents 304(1)-(N) retrieved at 302 may represent a collection of documents such as a collection of recently accessed documents, a collection of bookmarked documents, or a collection of top sites, for example. In the event that the documents 304(1)-(N) retrieved at 302 represent a collection of documents, the user 102 may request to retrieve the collection of documents at 310.

The documents 304(1)-(N) may include various combinations of text, images, or other content as shown in the illustrative examples that follow. A first document 304(1) may include mostly text, a second document 304(2) document may include mostly images, and a last document 304(N) may document include any combination of text and images such as document 304(N).

At 312, the key phrase extraction engine 126 extracts key phrases 314(1), 314(2), . . . , and 314(N) from each of the documents 304(1)-(N). In general, the key phrases 314(1)-(N) are extracted from the documents to reflect the main topics of the document. In some instances, a Key-Exchange (KEX) algorithm may be used to extract the key phrases 314(1)-(N) from the documents 304(1)-(N) at 312. In general, the KEX algorithm first extracts candidate phrases from the documents 304(1)-(N) and then the KEX algorithm filters the candidate phrases to select the key phrases 314(1)-(N) from among the candidate phrases which reflect the main topic of the documents.

The key phrase extraction engine 126 extracts the key phrases 314(1)-(N) from each of the documents 304(1)-(N) at 312. For example, the key phrase extraction engine 126 may extract key phrases 314(1) from the document 304(1), key phrases 314(2) from the document 304(2), and key phrases 314(N) from the document 304(N).

At 316, the image search engine 128 performs an image query using the key phrases 314(1)-(N) extracted at 312 to find candidate images 318(1), 318(2), . . . , and 318(N) which are relevant to each of the documents 304(1)-(N). In some embodiments, the image search engine 128 performs the image query by querying a database such as illustrated by the content providers 108(1)-(N) using the network 106 to find the candidate images 318(1)-(N).

For example, candidate images 318(1) which are obtained using each of the key phrases of 314(1) extracted from the document 304(1) may include a first subset of candidate images which are obtained by performing a first image query using the first key phrase, a second subset of candidate images which are obtained by performing a second image query using the second key phrase, and a third subset of candidate images which are obtained by performing an M^{th} image query using the M^{th} key phrase. Similarly, candidate images 318(2) are obtained by performing an image query using each of the key phrases 314(2) extracted from the document 304(2). The candidate images 318(N) are obtained by performing an image query using each of the key phrases 314(N) extracted from the document 304(N).

Although the candidate images 318(1)-(N) include nine images for each document, the image search engine 128 may generate any number of candidate images for each of the documents 304(1)-(N).

At 320, the ranking/filtering engine 130 filters the candidate images 318(1)-(N) to select a representative image 322(1), 322(2), . . . , and 322(N) from among the candidate images to visually represent each of the documents 304(1)-(N).

In some embodiments, the ranking/filtering engine 130 filters the candidate images 318(1)-(N). In general, the ranking/filtering engine 130 filters the candidate images 318(1)-(N) based on two assumptions: (1) images representative of a documents are likely to appear in other documents which are textually similar to the document, and (2) an image is generally representative of a document if more images are visually similar to the image. Accordingly, the ranking/filtering engine 130 filters the candidate images 318(1)-(N) based on a textually similarity of the candidate images to the documents as well as based on a visual filtering of the candidate images.

For instance, the ranking/filtering engine 130 performs the textual similarity using a cosine similarity based on vector space model (VSM). For example, first a Term Frequency Inverse Document Frequency (TFIDF) score is calculated for each term of both the image document and the document. Then the documents (i.e., the image document and the document) are each representing as a VSM that includes a vector for each term in the documents. Specifically, each vector of the VSM includes the TFIDF score that is calculated for each of the terms found in the documents. Finally cosine similarity is adopted to calculate the textual similarity between the image document and the document using the VSM's.

The ranking/filtering engine 130 may perform the visual filtering using a VisualRank algorithm. For instance, first a feature detection method such as Scale Invariant Feature Transform (SIFT) is used to identify local features (interest points) for each of the candidate images 318(1)-(N). Next, a visual similarity between each pair of candidate images is calculated based on a number of local features shared between the pair of candidate images divided by an average number of local features found in the sum of the pair of candidate images. Finally, a graph is constructed with the candidate images 318(1)-(N) as vertices and the calculated visual similarities as weights on the edges of the vertices. After the graph is constructed, an image ranking method such as PageRank is applied on the graph to calculate a visual importance score (i.e., “VRscore”) for each image that of the graph. In general, the candidate images which capture common themes among other candidate images will have a higher VRscore than images which do not capture common themes. In some instances, the ranking/filtering engine 130 may filter out visually unimportant images from among the candidate images 318(1)-(N) by filtering out candidate images that have a VRscore below a specific threshold. In some instances, the ranking/filtering engine 130 may use Equation 1 to filter out candidate images that have a VRscore below a specific threshold.

$$sim ( i , TW ) = \{ \begin{matrix}TI ( {CW}_{i} , TW ) , & VRScore > Threshold \\ 0 , & Otherwise\end{matrix} \qquad ( Equation 1 )$$

In Equation 1, CWᵢ denotes the image document of the i^{th} candidate image, TW denotes the document and TI(CWᵢ, TW) denotes the TFIDF cosine similarity between CWᵢ and TW (i.e., the TFIDF cosine similarity each of the image documents to the document of which the images represent), VRScore denotes the visual importance score computed by VisualRank, and Threshold is the specific threshold used to filter out images. In some instances, the Threshold may be set to the average VRScore for the candidate images 318(1)-(N).

In some instances, the representative images 322(1)-(N) may be external images obtained from sources other than the documents of which the images represent. As such, the document 304(1) is able to be represented visually by image 322(1) even though the document 304(1) may not contain or have internal links to any images.

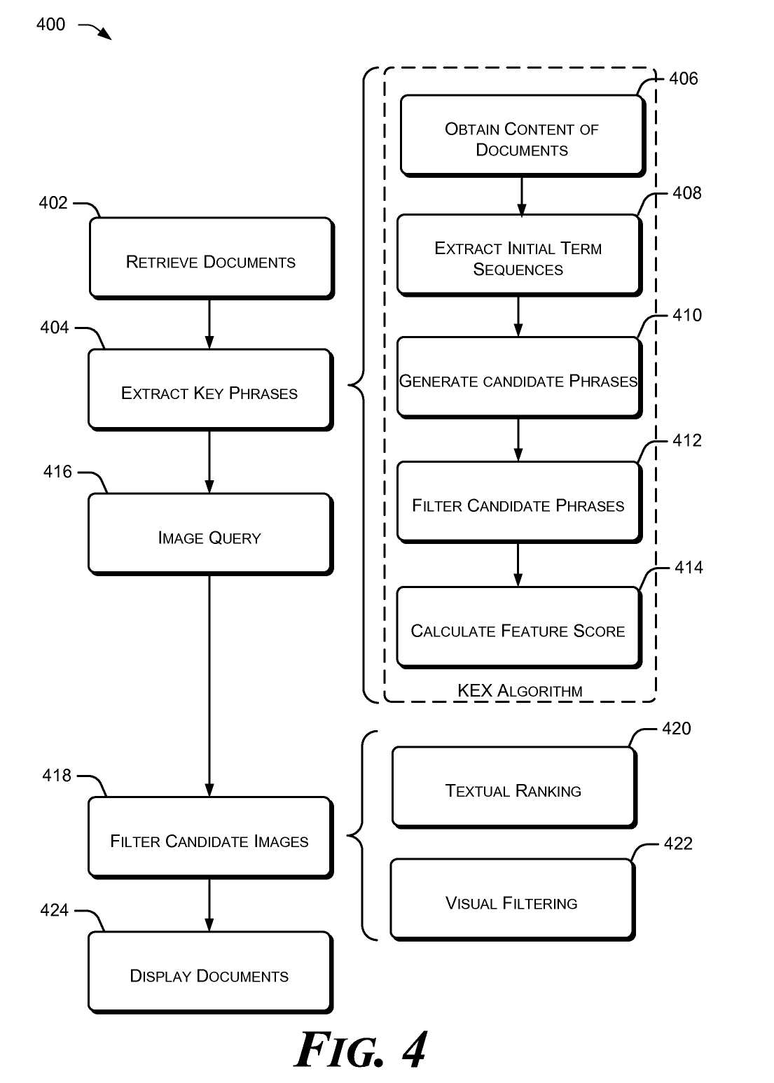

FIG. 4 is a flow diagram of an illustrative process 400 of performing techniques to visually summarize documents using external images obtained from sources other than the documents. The process 400 may be performed by the visual summarization engine 122. In some embodiments, process 400 further describes elements 312-320 of FIG. 3.

At 402, the visual summarization engine 122 retrieves one or more documents 304(1)-(N) (e.g., search results, a collection of documents, etc.) such as described with reference to element 302 of FIG. 3.

For example, the document search engine 124 may query a database such as illustrated by the content providers 108(1)-(N) using the network 106 to retrieve the documents (i.e., search results) at 402. Alternatively, the document search engine 124 may receive a request from the user 102 to access a collection of bookmarks to retrieve the documents (i.e., the collection of bookmarks) at 402.

At 404, the key phrase extraction engine 126 extracts key phrases 314(1)-(N) from the documents 304(1)-(N). In general, the key phrases 314(1)-(N) are selected from a body of the documents 304(1)-(N) and reflect the main topics of the document. In some instances, a KEX algorithm which is described further in blocks 406-414 may be used to extract the key phrases 314(1)-(N) from the documents 304(1)-(N).

For instance, at 406, the key phrase extraction engine 126 may obtain an entire content of the documents retrieved at 402. For instance, the document locator 214 (such as a uniform resource locator (URL)) that specifies where the document is available for retrieval may be used to obtain the entire content of the documents. At 408, the key phrase extraction engine 126 may extract initial term sequences from the entire content of the documents by splitting at least a portion of the entire content according to phrase boundaries (e.g., punctuation marks, dashes, brackets, and numbers).

At 410, the key phrase extraction engine 126 may generate candidate phrases using various subsequences of the initial term sequences extracted at 408. In some instances, the candidate phrases are generated using all subsequences of the initial term sequences up to a predetermined length such as four words. After generating the candidate phrases at 410, the key phrase extraction engine 126 may filter the candidate phrases at 412 using query logs. For example, the candidate phrases may be filtered at 412 to select one or more filtered candidate phrases.

At 414, the key phrase extraction engine 126 calculates a feature score for each of the filtered candidate phrases. In some instances, the feature score may be based on a structure and/or a textual content of the documents. For a more detailed explanation of the KEX algorithm, the reader is directed to a paper written by M. Chen, J.-T. Sun, H.-J. Zeng, and K.-Y. Lam, titled “A Practical System of Keyphrase Extraction for Web Pages,” published in CIKM '05: Proceedings of the 14th ACM international conference on Information and knowledge management, pages 277-278, New York, N.Y., USA, 4005, which is hereby incorporated by reference.

At 416, the image search engine 128 ranks the filtered candidate phrases based on their feature scores and then performs an image based query on the filtered candidate phrases which have the highest calculated feature scores. The image based query returns the candidate images 318(1)-(N) which are representative of the documents 304(1)-(N). In some embodiments, the image search engine 128 queries a database such as illustrated by the content providers 108(1)-(N) using the network 106 to find the candidate images 318(1)-(N). The image search engine 128 may be implemented as any image search engine such as, without limitation, Microsoft's Bing® image search engine to perform the image query at 416 to find the candidate images 318(1)-(N).

At 418, the ranking/filtering engine 130 filters the candidate images 318(1)-(N) (i.e., the one or images found by the image query) to select the representative image 322(1)-(N) which represents each of the documents 304(1)-(N). The ranking/filtering engine 130 may filter the candidate images 318(1)-(N) using the textual similarity and visual filtering techniques described above with reference to FIG. 3. For instance, the ranking/filtering engine 130 may filter the candidate images 318(1)-(N) by performing a textual ranking at 420 and/or a visual filtering at 422.

At 420, the ranking/filtering engine 130 performs textual ranking to rank each of the candidate images 318(1)-(N) based on a textual similarity between the image documents (i.e., the document from which the candidate images were extracted) and the documents (i.e., the document which the candidate images represent). As described above in FIG. 3, the textual similarity is calculated using a cosine similarity based on vector space model (VSM).

At 422, the ranking/filtering engine 130 performs visual filtering to filter out visually unimportant images from among the candidate images 318(1)-(N). As described above in FIG. 3, the ranking/filtering engine 130 performs visual filtering using a VisualRank algorithm in conjunction with an image ranking method such as PageRank to calculate a visual importance score (i.e., “VRscore”) for each image that of the graph. Specifically, the candidate images which capture common themes among other candidate images will have a higher VRscore than images which do not capture common themes.

The ranking/filtering engine 130 may filter the candidate images 318(1)-(N) at 418 using any combination of the textual ranking 420 and the visual filtering 422 to select the representative image 322(1)-(N) to represent each of the documents 304(1)-(N).

At 424 the visual summarization engine 122 renders a display 112 for viewing by the users 102. The display may include a representation of the one or more documents 304(1)-(N) retrieved at 402 including the representative image 322(1)-(N) which visually summarizes the documents. The representative images 304(1)-(N) may include a selection of external images obtained from sources other than the documents, thumbnail images, or internal images directly from the documents themselves.

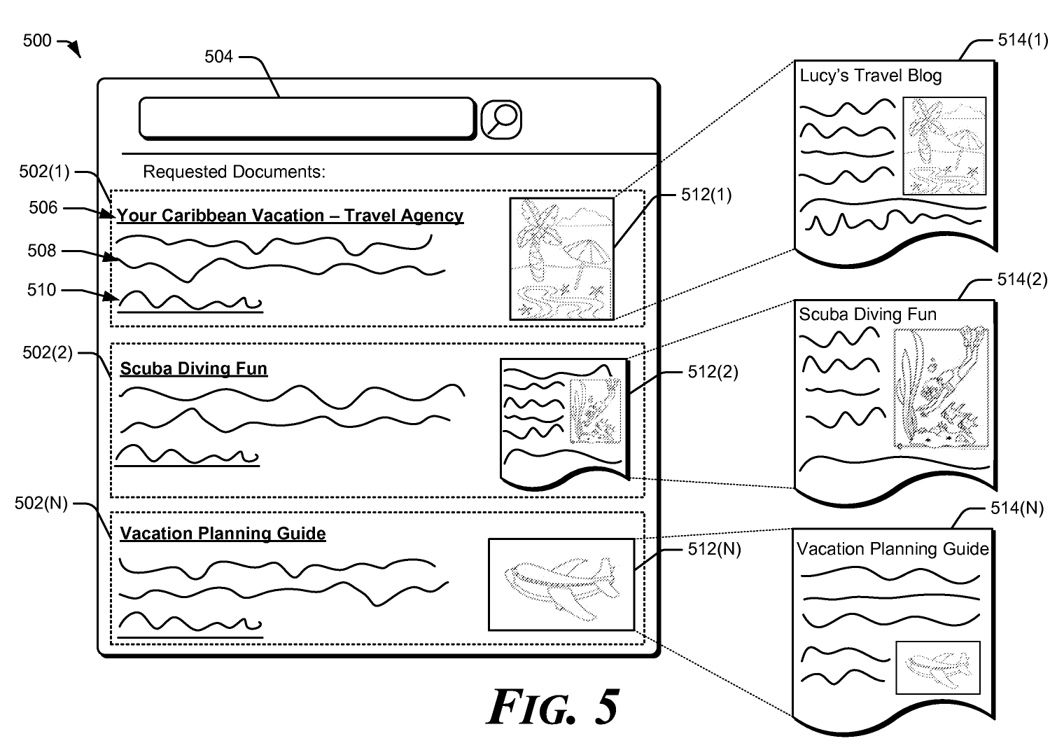

FIG. 5 is an illustrative web page 500 that may be operable to visually summarize documents using images which are a combination of external images obtained from sources other than the documents and images generated by other visual summarization techniques (e.g., thumbnail images, internal images taken directly from the documents themselves, etc.). The search engine(s) 110 may display the web page 500.

The illustrative web page 500 may display a list 502(1), 502(2), . . . , and 502(N) of one or more documents. In some embodiments, the list 502(1)-(N) of documents may represent search results which are retrieved via a search query. For example, the document search engine 124 may perform a document search using a search term such as “Caribbean Scuba Diving Vacations” received via the search term input box 504 to retrieve search results including a first web page titled “Your Caribbean Vacation—Travel Agency”, a second web page titled “Scuba Diving Fun” and a third web page titled “Vacation Planning Guide”. These search results may be represented by list elements 502(1), 502(2), and 502(N), respectively.

In other embodiments, the list 502(1)-(N) of documents may represent any set of documents including a collection of recently accessed documents, a collection of bookmarked documents, a collection of top sites, etc.

The representative documents of the list 502(1)-(N) may include any combination of information such as a document title 506 that reflects a title of the document, a snippet 508 that describes the document using one or more key phrases and/or a document locator 510 that specifies where the document is available for retrieval (e.g., a Uniform Resource Locator (URL)).

The representative documents in the list 502(1)-(N) may additionally include an image 512(1), 512(2), . . . , and 512(N) from image source documents 514(1), 514(2), . . . , and 514(N), respectively. For instance, list element 502(2) is a representation of image source document 514(2) titled “Scuba Diving Fun” which was included in the list of search results. Similarly, list element 502(N) is a representation of image source document 514(N) titled “Vacation Planning Guide.”

The images 512(1)-(N) may be images chosen from a selection of external images obtained from sources other than the documents, thumbnail images, or internal images taken directly from the documents themselves.

For example, image element 512(1) is an external image from image document 514(1). In some instances, image document 514(1) is not linked with the document of which list element 502(1) represents. In some embodiments, image 512(1) (i.e., external image) may be obtained from image document 514(1) using the processes of FIG. 3 and/or FIG. 4.

Image element 512(2) is a thumbnail image (i.e., a scaled-down snapshot image of the search result web page titled “Scuba Diving Fun”).

Image element 512(N) is an internal image obtained from the search result web page titled “Vacation Planning Guide”).

In some embodiments, an algorithm is used to choose the image type (external images, thumbnail images, or internal images taken directly from the documents themselves) that is best suited to visually represent each of the documents. For example, the algorithm may choose the image type that is included in the list 502(1)-(N) based on whether the document contains any salient images (e.g., for selection of an internal image) and/or further based on whether the document possesses discernable attributes when converted to a thumbnail image (e.g., the document has a simple structure which may be determined by analyzing one or more of a character count, frame count, image size, word count, and/or font size).

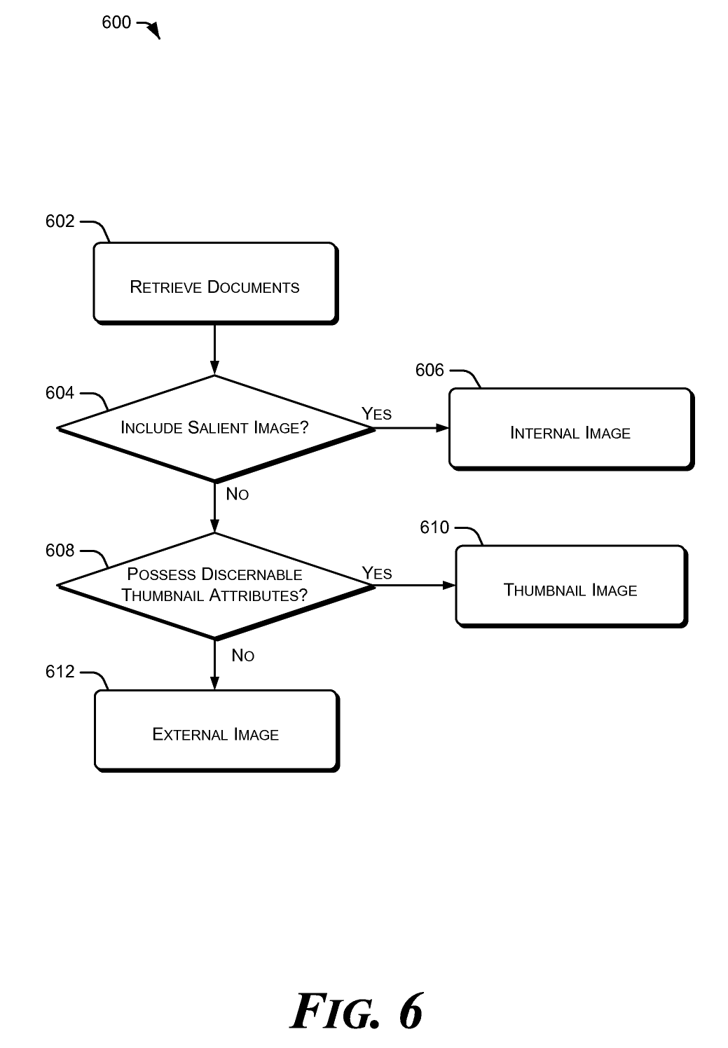

FIG. 6 depicts a flow diagram of a process 600 of determining which image type is best suited to visually summarize the documents. The image type may be selected from external images obtained from sources other than the documents, thumbnail images, or internal images taken directly from the documents. The process 600 may be performed by the visual summarization engine 122. For instance, the visual summarization engine 122 may execute a selection algorithm to perform the process 600.

At 602, the visual summarization engine 122 retrieves one or more documents. The documents may represent any document (e.g., search results, a collection of documents, etc.).

For example, the document search engine 124 may query a database such as illustrated by the content providers 108(1)-(N) using the network 106 to retrieve the documents (i.e., search results) at 602. Alternatively, the document search engine 124 may receive a request from the user 102 to access a collection of documents to retrieve the documents (i.e., the collection of collection) at 602.

At 604, the visual summarization engine 122 determines whether any of the documents contain a salient image. In general, salient images are images which reflect the main topic of the document of which the image is found. For example, if a document is about mountain biking, then a salient image may be an image of a person biking. The visual summarization engine 122 may determine whether the documents contain any salient images at 604 using a trained model which is based on three levels of image features. For instance, various properties of the image may be used to extract features from all the images in the documents. Next, the visual summarization engine determines a relationship of the images to the hosting document. An image dominance detection model can be obtained (learned) from labeled training samples, which may be represented as (x_{i,j}, y_{i,j}), where x_{i,j} is the extracted feature vector of the image i in the page j and y_{i,j} is its labeled dominance. A ranking model may then be employed to rank each image using an important level, namely 0 (useless), 1 (important) and 2 (highly important). Since the images are ranked using multiple levels (i.e., 0 to 2), a linear Ranking Support Vector Machine (SVM) model can be applied to train the ranking model in order to detect a presence of a salient image at 604. For a more detailed explanation of the detection of salient images, the reader is directed to a paper written by Q. Yu, S. Shi, Z. Li, J.-R. Wen, and W.-Y. Ma, titled “Improve ranking by using image information,” published in ECIR'07: Proceedings of the 29th European conference on IR research, pages 645-652, 2007, which is hereby incorporated by reference.

If the documents do contain salient images (i.e., the “yes” branch at block 604), then the documents may be represented by an internal image at 606 which is obtained directly from the documents. If the documents do not contain salient images (i.e., the “no” branch at block 604), then process 600 proceeds to block 608.

At 608, the visual summarization engine 122 analyzes the documents to determine whether any of the documents may be discernibly recognizable using a scaled-down snapshot image (thumbnail) of the document itself as rendered by a web browser. In some embodiments, the visual summarization engine 122 may analyze the characters of the documents to determine if the documents are discernibly recognizable using the thumbnail image. For example, if the documents contain a character count that is greater than a threshold character count, then the visual summarization engine may determine that the documents are discernibly recognizable using a thumbnail image at 608. If the documents has a simple number of frames (i.e., a frame count is less than a threshold frame count), then the visual summarization engine may determine that the documents are discernibly recognizable using a thumbnail image at 608. If the documents has a small number of images (i.e., an image count is less than a threshold image count) and/or the documents has a small number of words (i.e., a word count is less than a threshold word count), and/or the documents has a large font size (i.e., a font size or average font size is greater than a threshold font size), then the visual summarization engine may determine that the documents are discernibly recognizable using a thumbnail image at 608.

In summary, the visual summarization engine 122 may analyze any combination of character count, font count, image size, word count, and/or font size of the documents to determine if the documents are discernibly recognizable using the thumbnail image at 608.

If the documents posses discernable thumbnail attributes using any of the above mention criteria, for example, (i.e., the “yes” branch at block 608), then the documents may be represented by a thumbnail image at 610.

If the documents fail to posses discernable thumbnail attributes (i.e., the “no” branch at block 608), then the documents may be represented by an external image at 612 which is obtained from a source other than the documents.

For instance, if the visual summarization engine 122 determines to represent the document using an external image at 612, then the visual summarization engine may select the external image to represent that documents using the process of FIG. 3 or FIG. 4. On the other hand, if the visual summarization engine 122 determines to represent the document using an internal image or a thumbnail image, then the visual summarization engine may find or generate the internal image or thumbnail image using techniques known in the art.

If the visual summarization engine 122 retrieves multiple documents at 602, then blocks 604-612 of process 600 may be performed for each document individually.

The process 600 of FIG. 6 may be performed using any combination of the logic elements depicted in FIG. 6. In various embodiments, the visual summarization engine 122 may omit step 608 in the process 600. For instance, the visual summarization engine 122 determines whether any of the documents contain a salient image at 604. Then if the documents do not contain salient images (i.e., the “no” branch at block 604), then process 600 may proceed directly to block 612 where the document is represented by an external image which is obtained from a source other than the documents. Similarly, in some embodiments, the visual summarization engine 122 may omit step 604 in the process 600.

### Additional Illustrative Document Summarization Applications

The techniques described herein may be used in applications other than document searching. For instance, the techniques may be used to summarize any collection of documents using representative images. For example, the techniques may be used in accordance with a collection of recently accessed documents (i.e., document history), a collection of bookmarks (i.e., a repository where users can store documents of interest), or a collection of top sites.

In general, whenever a user accesses a document, such as via a web browser, a link to the document may be stored in memory as a recently accessed document so that the user can later re-find the document easily. As the user accesses more and more documents, the collection of recently accessed documents may become larger. In some instances, the collection of recently accessed documents may be presented to the user so that the user may be reminded of their recent document browsing activities and possibly even re-visit a document that was previously visited. As the user continues to actively browse documents, the collection of recently accessed documents may be updated dynamically.

In general, the collection of bookmarks is similar to the collection of recently accessed documents. However, in order for a document to be added to the collection of bookmarks, the user may need to perform an action to indicate their desire to add the document to the collection. Similar to the collection of recently accessed documents, the collection of bookmarks may be stored in a memory and may be updated dynamically as the user actively adds or removes documents from the collection.

In general, top sites feature a collection of documents which automatically populated by sites that are most visited by the general public. Since the generally public is continuously visiting documents, the collection of top sites is continually updated dynamically with the most visited documents.

Regardless of whether the collection of documents represents recently accessed documents, bookmarks, or top sites, the documents of the collection may be represented using the techniques described herein. In other words, rather than summarizing the collection of documents using text such as a document locator and title, the collection of documents may be represented by images which visually summarize a content of the documents.

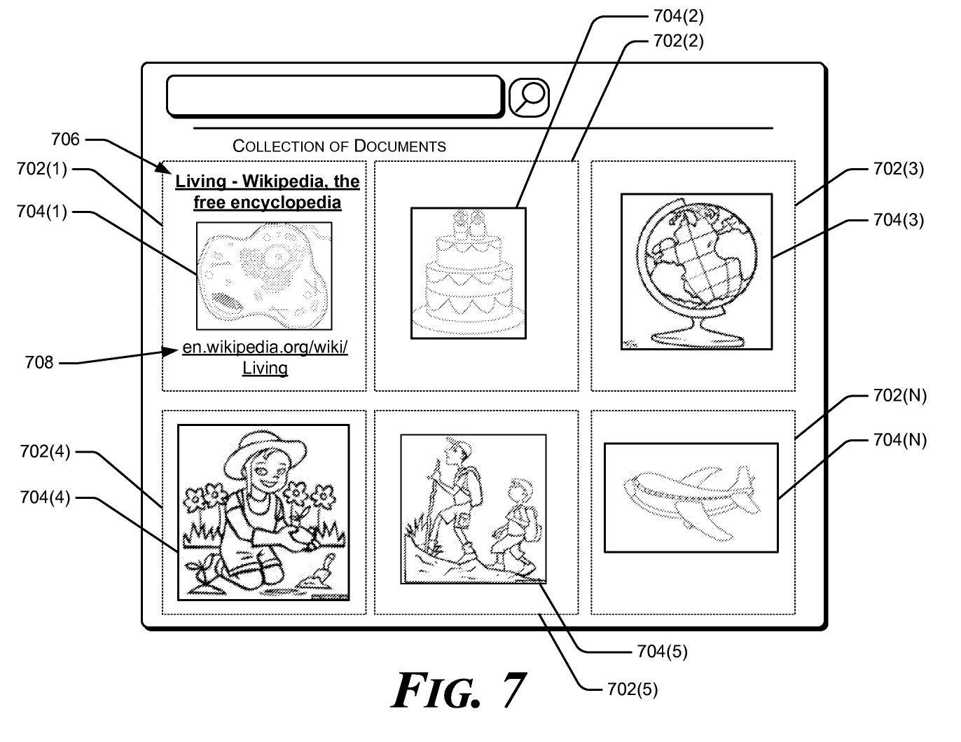

FIG. 7 is an illustrative web page 700 that may be operable to display a collection of documents as a list 702(1), 702(2), . . . , and 702(N) of representative documents where each element in the list 702(1)-(N) is a representation of each of the documents in the collection, respectively. In some instances, the search engine(s) 110 may display the web page 700. The collection of documents may represent any set of document such as a collection of recently accessed documents, a collection of bookmarked documents, a collection of top sites, etc.

The list 702(1)-(N) of documents may include images 704(1), 704(2), . . . , and 704(N) which visually represent each document in the list. The list 702(1)-(N) may additionally include a document title 706 that reflects a title of the document, and/or a document locator 708 that specifies where the document is available for retrieval.

The images 704(1)-(N) may be of any image type chosen from a selection of external images obtained from sources other than the collection of documents, thumbnails, and/or internal images obtained directly from the collection of documents. For instance, an algorithm such as illustrated in FIG. 6 may be used to choose an image type (e.g., external images obtained from sources other than the collection of documents, thumbnail images, or internal imaged taken directly from the collection of documents), that is suited to visually summarize each of the documents in the collection.

In some instances, the image type is determined based on a structure of the documents in the collection. For example, if the documents in the collection contain salient images, then the documents in the collection may be represented by an internal image obtained directly from the collection of documents. As another example, if the documents in the collection possess discernable attributes when converted to a thumbnail image (i.e., the document has a simple structure which may be determined by analyzing one or more of a character count, frame count, image size, word count, and/or font size), then the documents may be represented by a thumbnail image. As a further example, if the documents in the collection do not contain any salient images and lack discernable attributes when converted to a thumbnail image, then the documents may be represented by an external image obtained from a source other than the collection of documents.

The list 702(1)-(N) of documents in the collection may be updated dynamically such that whenever a new document is added to the collection, the visual summarization engine 122 automatically adds the new document to the collection along with an image that represents the new document. In some instances, the images 704(1)-(N) are hyperlinks. For example, the user may click on the images 704(1)-(N) to open the documents which are listed in the collection.

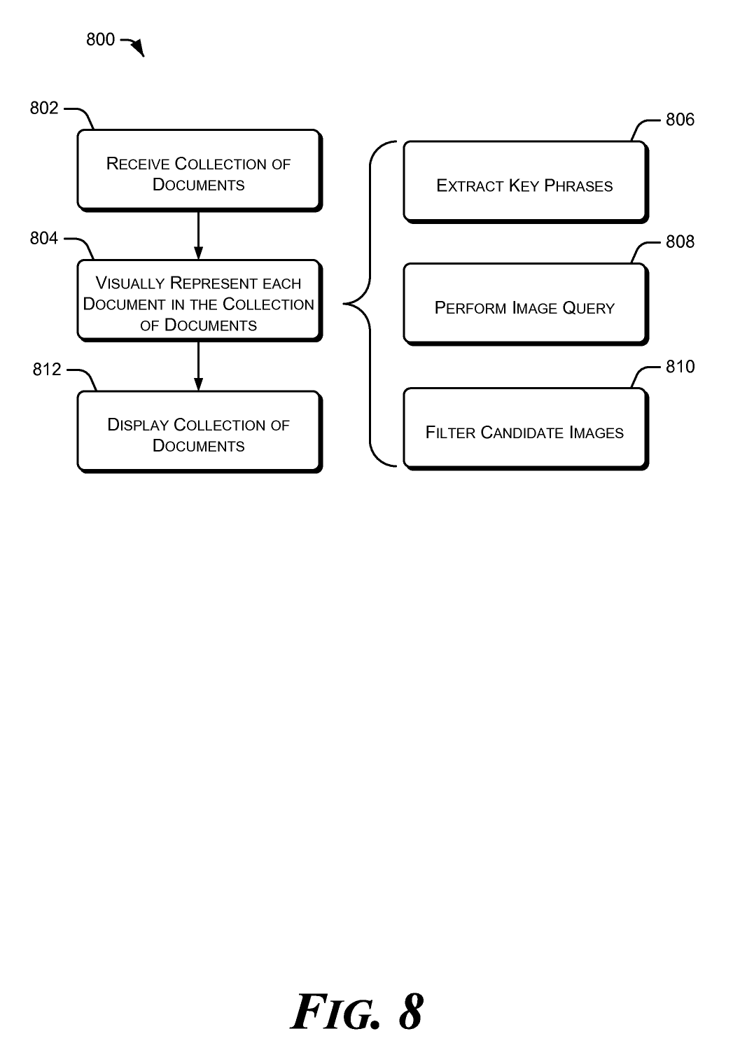

FIG. 8 is a flow diagram of an illustrative process 800 of visually summarizing a collection of documents using representative images. The process 800 may be performed by the visual summarization engine 122.

At 802, the visual summarization engine 122 receives a collection of documents. The collection of documents may represent any collection of documents such as without limitation a collection of recently accessed document, a collection of bookmarks, and/or a collection of top sites.

At 804, the visual summarization engine 122 visually represents each document in the collection of documents using an image. In some instances, an algorithm may choose the image type, which may be chosen from a selection of external images, thumbnail images, or internal imaged taken directly from the collection of documents, that is suited to represent each document in the collection of documents. The algorithm may choose the image type based on whether the document contains any salient images and/or whether the document possesses discernable attributes when converted to a thumbnail image.

In the event that visually representing one or more documents in the collection of documents at 804 includes obtaining an external image to visual represent a document in the collection, the visual summarization engine 122 may obtain the external image by extracting key phrases at 806, performing an image query at 808 using the key phrases extracted at 806 to find candidate images which are relevant to the document, and filtering the candidate images at 810 to select a representative image from among the candidate images.

At 812, the visual summarization engine 122 displays a snippet of the collection of documents along with the images which visually represents each document in the collection.

### CONCLUSION

Although the techniques have been described in language specific to structural features and/or methodological acts, it is to be understood that the appended claims are not necessarily limited to the specific features or acts described. Rather, the specific features and acts are disclosed as illustrative forms of implementing such techniques.

What is claimed is:

1. A method of performing external image based visual summarization, the method comprising:
retrieving a document;
determining a key phrase of the document that represents a main topic of the document;
performing an image search based at least in part on the key phrase to identify one or more candidate images;
selecting a representative image from the candidate images to visually represent the document; and
displaying a representation of the document including the representative image.

2. The method of claim 1, wherein the one or more candidate images are unassociated with the document by being external to the document and not included in internal links of the document.

3. The method of claim 1, wherein the determining the key phrase comprises:
obtaining an entire content of the document;
splitting at least a portion of the entire content according to phrase boundaries to extract one or more initial term sequences;
generating candidate phrases using various subsequences of the one or more initial term sequences;
filtering the candidate phrases to select one or more filtered candidate phrases;
calculating a feature score for each of the filtered candidate phrases, the feature score associated with both a structure and a textual content of the document; and
determining the key phrase from the filtered candidate phrases based at least in part on the feature score.

4. The method of claim 1, wherein the selecting the representative image includes ranking the candidate images based on a textual similarity between an image source document of which the candidate images are associated and the document.

5. The method of claim 1, wherein the retrieving the document includes performing a search query using one or more search terms to retrieve the document.

6. The method of claim 1, wherein the retrieving the document includes retrieving a collection of documents.

7. The method of claim 1, wherein the displaying the representation of the document includes displaying a snippet of the document.

8. One or more computer-readable media storing computer-executable instructions that, when executed, cause the one or more processors to perform acts comprising:
retrieving a set of documents;
selecting representative images to visually represent the set of documents, where each document has a corresponding image, the representative images including an external image that visually represents a first corresponding document, the external image obtained by:
extracting a key phrase from the first corresponding document,
performing a search for candidate images based at least in part on the key phrase, the candidate images present within one or more image documents that are unassociated with the first corresponding document by being eternal to the first corresponding document and not included in internal links in the first corresponding document, and
selecting external image from the candidate images; and
displaying the set of documents including the representative images.

9. The one or more computer-readable media as recited in claim 8, wherein the representative images further include an internal image that visually represents a second corresponding document, the internal image embedded within or linked to the second corresponding document.

10. The one or more computer-readable media as recited in claim 8, wherein the representative images further include a thumbnail image that visually represents a third corresponding document, the thumbnail image being a scaled down snapshot of the third corresponding document.

11. The one or more computer-readable media as recited in claim 8, wherein the acts further comprising executing an algorithm to choose image types for the representative images, where each representative image has a corresponding image type chosen from a selection of external images, thumbnail images, or internal images.

12. The one or more computer-readable media as recited in claim 8, wherein the acts further comprising ranking each of the candidate images based on a textual similarity between a source of the corresponding image and the first corresponding document.

13. The one or more computer-readable media as recited in claim 8, wherein the acts further comprising:
obtaining an entire content of the first corresponding document;
splitting at least a portion of the entire content according to phrase boundaries to extract one or more initial term sequences;
generating candidate phrases using various subsequences of the one or more initial term sequences;
filtering the candidate phrases to select one or more filtered candidate phrases;
calculating a feature score for each of the filtered candidate phrases, the feature score associated with a structure and a textual content of the first corresponding document; and
determining the key phrase based on the feature score.

14. The one or more computer-readable media as recited in claim 8, wherein the acts further comprising performing a document search using a search query to retrieve the set of documents.

15. The one or more computer-readable media as recited in claim 8, wherein the computer-executable instructions to retrieve the set of documents includes computer-executable instructions to retrieve one of a collection of recently accessed documents, a collection of bookmarked documents, or a collection of top sites.

16. One or more computer-readable media storing computer-executable instructions that, when executed, cause the one or more processors to perform acts comprising:
retrieving one or more documents;
for each document, executing an algorithm to select a representative image to visually represent the document, the representative image being one of:
an internal images taken directly from the document when the document contains a salient image, and
an external image selected via an image search using a key phrase extract from the document when the document does not contain the salient image; and
rendering the representative image for display along with a representation of the document.

17. The one or more computer-readable media as recited in claim 16, wherein the representative image further being one of a thumbnail image when the document is discernibly recognizable as a scaled down snapshot image of the document.

18. The one or more computer-readable media as recited in claim 16, wherein the acts further comprising rendering the representative image for display along with one or more of a document title that reflects a title of the document, a snippet that describes the document using a phrase, and a document locator that specifies where the document is available for retrieval.

19. The one or more computer-readable media as recited in claim 16, wherein the acts further comprising performing a document search using a search query to retrieve the one or more documents.

20. The one or more computer-readable media as recited in claim 16, wherein the acts further comprising:
obtaining one or more candidate images via the imaged based search;
ranking each of the candidate images based on a textual similarity between the document and a source of the candidate images; and
filtering out visually unimportant images from the candidate images.
